(19) United States
(12) Patent Application Publication
(10) Pub. No.: US 2023/0140364 A1
(43) Pub. Date: May 4, 2023

(54) AC Filter Sensor System

(71) Applicant: Sachin Uttamchandani, Cutler Bay, FL (US)

(72) Inventor: Sachin Uttamchandani, Cutler Bay, FL (US)

(21) Appl. No.: 18/052,319

(22) Filed: Nov. 3, 2022

Related U.S. Application Data
(60) Provisional application No. 63/275,688, filed on Nov. 4, 2021.

(51) Int. Cl. F24F 11/39; F24F 11/88; F24F 11/52; G06Q 10/00

(52) U.S. Cl. CPC F24F 11/39; F24F 11/88; F24F 11/52; G06Q 10/20; F24F 2110/40

(57) ABSTRACT

The present invention relates to an AC filter sensor system that monitors the lifespan of an AC filter. The system is primarily comprised of a device, a mobile application, and a method of use. The device can be placed within an AC unit wherein a sensor and a transducer of the device measure pressure differential within the unit to allow the device to determine when an air filter needs to be replaced. The device then communicates this information to the mobile application, which alerts the user that the filter needs replaced and may also alert a filter supplier who can then ship a filter to the user.

### CROSS-REFERENCE TO RELATED APPLICATION

The present application claims priority to, and the benefit of, U.S. Provisional Application No. 63/275,688, which was filed on Nov. 4, 2021, and is incorporated herein by reference in its entirety.

### FIELD OF THE INVENTION

The present invention relates generally to the field of air-conditioning and HVAC units. More specifically, the present invention relates to an AC filter sensor system primarily comprised of a device, a mobile application, and a method of use. The device can be placed within an AC unit wherein a sensor and a transducer of the device measure pressure differential within the unit to allow the device to determine when an air filter needs to be replaced. The device then communicates this information to the mobile application, which alerts the user that the filter needs replaced. In addition, the mobile application may also alert a filter supplier, who can then ship a filter to the user. This ensures that a user is aware when their filter needs changed, and also eliminates the need for a user to immediately purchase a replacement filter on their own. Accordingly, the present disclosure makes specific reference thereto. Nonetheless, it is to be appreciated that aspects of the present invention are also equally applicable to other like applications, devices, and methods of manufacture.

### BACKGROUND

Air conditioning units (AC units) and other HVAC systems require a filter to function properly. However, many individuals may be unaware of when they should change their AC unit and/or HVAC filter. As a result, some individuals may change their filters prematurely. This is not only a waste of money but may lead to dirty coils, HVAC failures, and indoor air quality issues. However, regular service calls to ensure filters are changed properly can be expensive.

Therefore, there exists a long-felt need in the art for an AC filter sensor system. More specifically, there exists a long-felt need in the art for an AC filter sensor system that notifies a user that the filter of the AC unit needs to be changed. In addition, there exists a long-felt need in the art for an AC filter sensor system that prevents users from changing their AC filter prematurely or in a late manner. Further, there exists a long-felt need in the art for an AC filter sensor system that ensures an AC filter remains clean and operational.

The subject matter disclosed and claimed herein, in one embodiment thereof, comprises an AC filter sensor system. The system is primarily comprised of a device, a mobile application, and a method of use. The device can be placed within an AC unit such that a sensor and a transducer of the device measure pressure differential within the unit. This allows the device to determine when an air filter needs to be replaced. The device then communicates this information to the mobile application, which alerts the user that the filter needs replaced. The mobile application may also alert a filter supplier, who can then ship a filter to the user.

In this manner, the AC filter sensor system of the present invention accomplishes all of the forgoing objectives and provides an AC filter sensor system that prevents users from changing their AC filter prematurely or in a late manner. The system also ensures an AC filter remains clean and operational. To do so, the system notifies a user that the filter of the AC unit needs to be changed.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an AC filter sensor system. The system is primarily comprised of a device, a mobile application, and a method of use. The device is comprised of a body that is preferably L-shaped. However, the body may be any shape and size known in the art in different embodiments. The device can be positioned within an AC unit by attaching to the unit and/or a filter of the unit. The body may be comprised of at least one fastener that allows the device to attach to the inside of an AC unit.

The device is also comprised of at least one sensor that preferably wirelessly communicates with the mobile application of the system. The sensor is also in wired or wireless communication with at least one transducer comprised of at least one port. The sensor measures the pressure within the AC unit, wherein the transducer then measures the excess differential pressure that is detected by the sensor and relays the information back to the sensor and to the mobile application.

The mobile application is comprised of a mobile application and/or computer software. The application can be installed on a smart device and is comprised of a notification feature, an information input feature, and a tracking feature. Once the transducer establishes that a threshold pressure differential is present within the AC unit and communicates to the mobile application that the threshold has been exceeded, the mobile application sends at least one notification to an AC/HVAC filter supplier, vendor, store, etc. and to a user of the mobile application. The notification informs the user and supplier that the AC unit needs a new filter. The mobile application also allows a replacement filter to be purchased and shipped to the location of the user.

The system is also comprised of a method of use. First, the device is placed within an AC unit, wherein the device detects the pressure differential within the AC unit to determine when a filter within the AC unit needs to be replaced. Once detected, the need for the filter to be replaced is then communicated from the device to the mobile application, which alerts a user and a supplier of filters. Using information provided by the user, the supplier can then mail the user a new filter.

Accordingly, the AC filter sensor system of the present invention is particularly advantageous as it provides an AC filter sensor system that prevents users from changing their AC filter prematurely or in a late manner. The system also ensures an AC filter remains clean and operational. To do both, the system notifies a user that the filter of the AC unit needs to be changed via the mobile application. In this manner, the AC filter sensor system provides a novel solution to replacing AC filters in a timely and efficient manner.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a device of one potential embodiment of an AC filter sensor system of the present invention in accordance with the disclosed architecture;

FIG. 2 illustrates a perspective view of a device of one potential embodiment of an AC filter sensor system of the present invention while inside an AC unit in accordance with the disclosed architecture;

FIG. 3 illustrates a perspective view of a device of one potential embodiment of an AC filter sensor system of the present invention in accordance with the disclosed architecture;

FIG. 4 illustrates a block diagram of a mobile application of one potential embodiment of an AC filter sensor system of the present invention in accordance with the disclosed architecture; and

FIG. 5 illustrates a flowchart of a method of using one potential embodiment of an AC filter sensor system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an AC filter sensor system. More specifically, there exists a long-felt need in the art for an AC filter sensor system that notifies a user that the filter of the AC unit needs to be changed. In addition, there exists a long-felt need in the art for an AC filter sensor system that prevents users from changing their AC filter prematurely or in a late manner. Further, there exists a long-felt need in the art for an AC filter sensor system that ensures an AC filter remains clean and operational.

The present invention, in one exemplary embodiment, is comprised of an AC filter sensor system primarily comprised of a device, a mobile application, and a method of use. The device is comprised of a body that is preferably L-shaped. However, the body may be any shape and size known in the art in different embodiments. The device can be positioned within an AC unit by attaching to the unit and/or a filter of the unit. The body may be comprised of at least one fastener that allows the device to attach to the inside of an AC unit.

The device is also comprised of at least one sensor. The sensor preferably wirelessly communicates with the mobile application of the system. The sensor is also in wired or wireless communication with at least one transducer comprised of at least one port. The sensor measures the pressure within the AC unit. The transducer then measures the excess differential pressure that is detected by the sensor and relays the information back to the sensor and to the mobile application.

The mobile application is comprised of a mobile application and/or computer software that can be installed on a smart device and is comprised of a notification feature, an information input feature, and a tracking feature. Once the transducer establishes that a threshold pressure differential is present within the AC unit and communicates to the mobile application that the threshold has been exceeded, the mobile application sends at least one notification to an AC/HVAC filter supplier, vendor, store, etc. and to a user of the mobile application. The notification informs the user and supplier that the AC unit needs a new filter. The mobile application also allows a replacement filter to be purchased and shipped to the location of the user.

The system is also comprised of a method of use. First, the device is placed within an AC unit, wherein the device detects the pressure differential within the AC unit to determine when a filter within the AC unit needs to be replaced. Once detected, the need for the filter to be replaced is then communicated from the device to the mobile application, which alerts a user and a supplier of filters. Using information provided by the user, the supplier can then mail the user a new filter.

Accordingly, the AC filter sensor system of the present invention is particularly advantageous as it provides an AC filter sensor system that prevents users from changing their AC filter prematurely or in a late manner. The system also ensures an AC filter remains clean and operational. To do both, the system notifies a user that the filter of the AC unit needs to be changed via the mobile application. In this manner, the AC filter sensor system provides a novel solution to replacing AC filters in a timely and efficient manner.

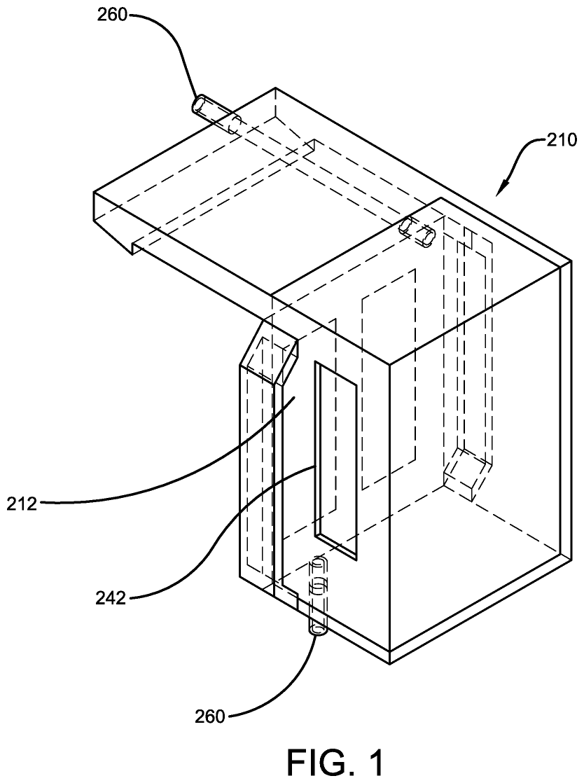

Referring initially to the drawings, FIG. 1 illustrates a perspective view of a device 200 of one potential embodiment of an AC filter sensor system 100 of the present invention in accordance with the disclosed architecture. The system 100 is primarily comprised of a device 200, a mobile application 300, and a method of use 400. The device 200 is comprised of a body 210. The body 210 is preferably L-shaped. However, the body 210 may be any shape and size known in the art in different embodiments. As will be described more fully below, the device 200 can be positioned within an AC unit 10 by attaching to the unit 10 and/or a filter 12 of the unit 10. The device 200 may be positioned anywhere within the AC unit 10. However, the device 200 is preferably positioned near (or on) the filter 12 of the AC unit 10.

The body 210 is preferably made from a corrosion-resistant metal material such as but not limited to stainless steel or aluminum. In another embodiment, the body 210 is made from a rigid plastic such as but not limited to acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

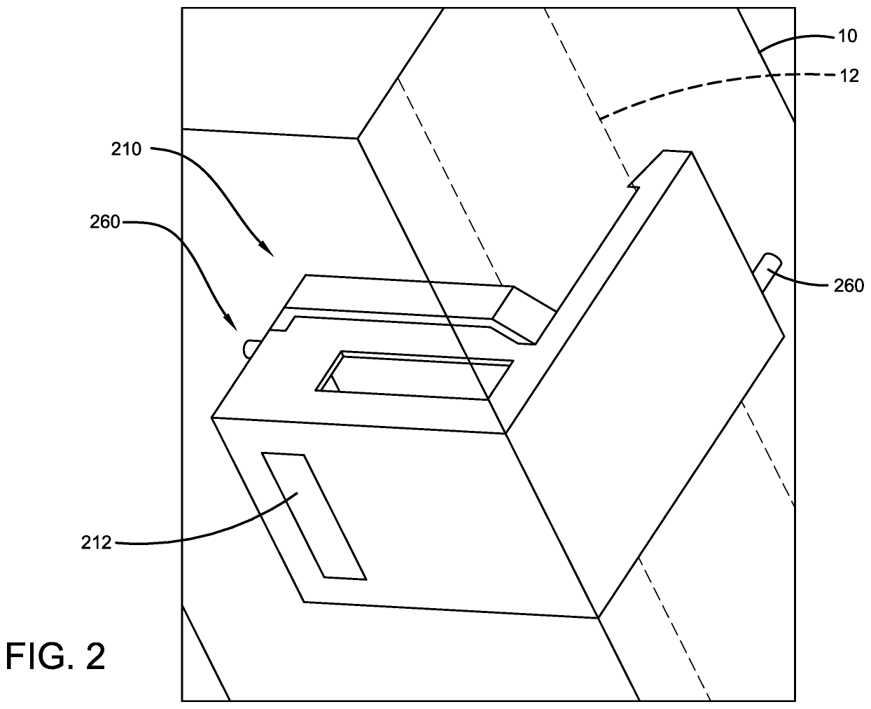

The body 210 may be comprised of at least one fastener 212, as seen in FIG. 2. The fastener 212 allows the device 100 to attach to the inside of an AC unit 10. In one embodiment, the fastener 212 is comprised of a magnet. In another embodiment, the fastener 212 is a screw or other fastener known in the art. In one embodiment, the fastener 212 penetrates or passes through the body 210.

The device 200 is also comprised of at least one sensor 220. In the preferred embodiment, the sensor 220 can wirelessly communicate with a mobile application 300 of the system 100. The sensor 200 may communicate to the mobile application 300 via any wireless connection method known in the art such as but not limited to Wi-Fi, Bluetooth, RFID, etc.

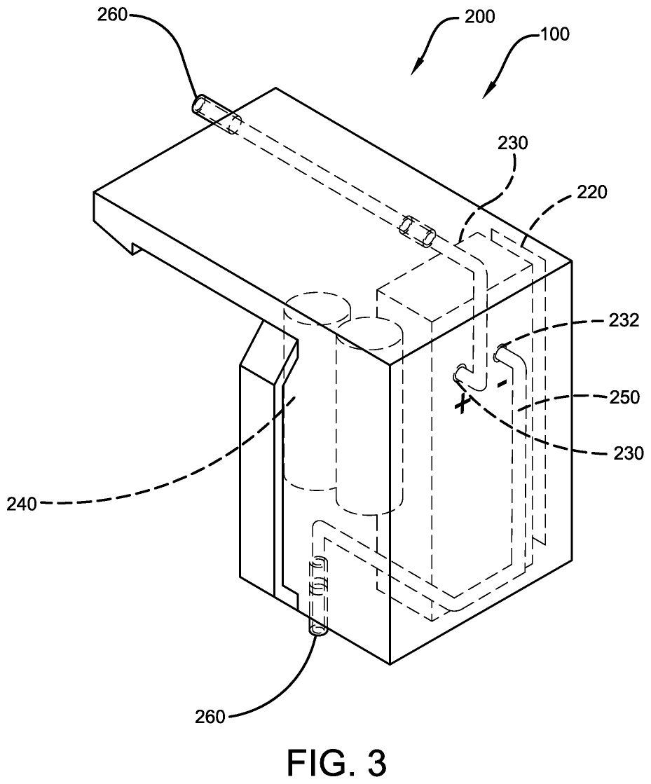

The sensor 220 is in wired or wireless communication with at least one transducer 230, as seen in FIG. 3. The transducer 230 is comprised of at least one port 232. However, the transducer 230 is preferably comprised of two ports 232 wherein one port 232 is a high port and the other port is a low port 232. The ports 232 may be 5×2×2 cube ports, or any port type known in the art.

All electrical components of the device 200 are powered by at least one battery 240. The battery 240 is positioned within the body 210. The battery 240 may be a disposable battery 240 or a rechargeable battery 240 in the form of an alkaline, nickel-cadmium, nickel-metal hydride battery 240, etc. such as any 3V-12volts DC battery 240 or other conventional battery 240 such as A, AA, AAA, etc. that supply power to the device 100. Throughout this specification the terms “battery” and “batteries” may be used interchangeably to refer to one or more wet or dry cells or batteries 240 of cells in which chemical energy is converted into electricity and used as a source of DC power. References to recharging or replacing batteries 240 may refer to recharging or replacing individual cells, individual batteries 240 of cells, or a package of multiple battery cells as is appropriate for any given battery 240 technology that may be used. The battery 240 may be accessed by at least one battery door or cover 242. Notwithstanding, it is also contemplates that the device 100 may be powered by the AC unit and the battery 240 used as a backup.

In one embodiment, the device 200 is comprised of at least one hose 250. The hose 250 is preferably but is not limited to a neoprene hose. However, the hose 250 may be any shape known in the art relating to AC and HVAC units. The hose 250 may connect to at least one, but preferably two ports 250. The two ports 250 are preferably inlet and outlet ports. The ports 250 may connect to the ports 232 of the transducer 230 (or may be the ports 232 of the transducer 230 in one embodiment).

The sensor 220 measures the pressure within the AC unit 10. The transducer 230 then measures the excess differential pressure that is detected by the sensor 220 and relays the information back to the sensor 220 and to the mobile application 300. Although, in one embodiment the transducer 230 may relay the information back to the mobile application 300.

The mobile application 300 is comprised of a mobile application and/or computer software. The application 300 can be installed on a smart device such as but not limited to a cell phone, a tablet, a computer, etc. The application 300 is comprised of a notification feature 302, an information input feature 304, and a tracking feature 306.

Once the transducer 230 establishes that a threshold pressure differential is present within the AC unit 10 and communicates to the mobile application 300 that the threshold has been exceeded, the mobile application 300 sends at least one notification alert 302. The notification may be sent to an AC/HVAC filter supplier, vendor, store, etc., and to a user of the mobile application 300. The notification 302 informs the user and supplier that the AC unit 10 needs a new filter 302.

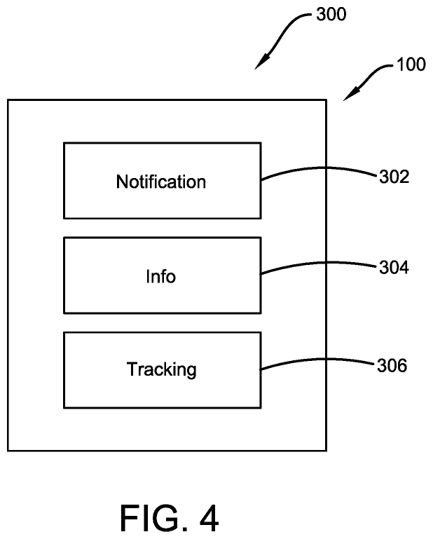

FIG. 4 illustrates a block diagram of a mobile application 300 of one potential embodiment of an AC filter sensor system 100 of the present invention in accordance with the disclosed architecture. The user can input information into the mobile application 300 using the information feature 304. This includes but is not limited to shipping address, billing address, payment information, etc. This allows the replacement filter to be purchased and shipped to the location of the user. The tracking feature 306 then allows a user to track the location of the filter in real-time once shipped.

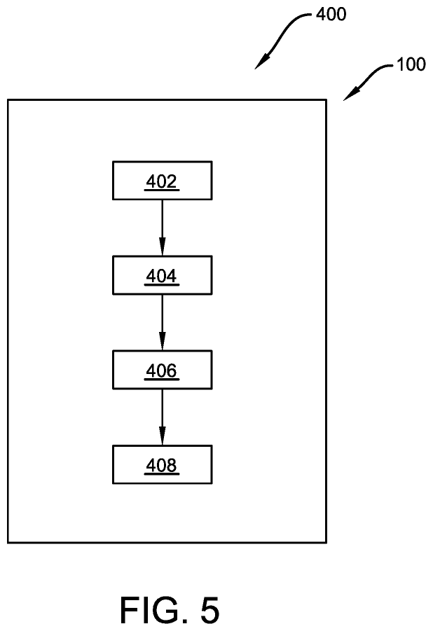

FIG. 5 illustrates a flowchart of a method of using 400 one potential embodiment of an AC filter sensor system 100 of the present invention in accordance with the disclosed architecture. The system 100 is also comprised of a method of use 400. First, the device 100 is placed within an AC unit 10 [Step 402]. Then, the device 100 detects the pressure differential within the AC unit 10 to determine when a filter 12 within the AC unit 10 needs replaced [Step 404]. The need for the filter 12 to be replaced is then communicated from the device 100 to the mobile application 300, which alerts a user and a supplier of filters 12 [Step 406]. Using information 304 provided by the user, the supplier can then mail the user a new filter 12 [Step 408].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “AC filter sensor system” and “system” are interchangeable and refer to the AC filter sensor system 100 of the present invention.

Notwithstanding the forgoing, the AC filter sensor system 100 of the present invention and its various components can be of any suitable size and configuration as is known in the art without affecting the overall concept of the invention, provided that they accomplish the above-stated objectives. One of ordinary skill in the art will appreciate that the size, configuration and material of the AC filter sensor system 100 as shown in the FIGS. are for illustrative purposes only, and that many other sizes and shapes of the AC filter sensor system 100 are well within the scope of the present disclosure. Although the dimensions of the AC filter sensor system 100 are important design parameters for user convenience, the AC filter sensor system 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An AC filter sensor system comprising:
a device comprised of a body, a sensor, a transducer and a battery; and
a mobile application.

2. The AC filter sensor system of claim 1, wherein the sensor is in wired communication with the transducer.

3. The AC filter sensor system of claim 1, wherein the transducer is comprised of a port.

4. The AC filter sensor system of claim 1, wherein the body is comprised of a battery door cover.

5. An AC filter sensor system comprising:
a device comprised of a body, a sensor, a transducer, a port, a hose and a battery; and
a mobile application having a notification feature.

6. The AC filter sensor system of claim 5, wherein the device further comprises a fastener.

7. The AC filter sensor system of claim 6, wherein the fastener is comprised of a magnet.

8. The AC filter sensor system of claim 5, wherein the sensor is in wireless communication with the transducer.

9. The AC filter sensor system of claim 8, wherein the sensor is a pressure sensor.

10. The AC filter sensor system of claim 8, wherein the transducer is a pressure differential measuring transducer.

11. The AC filter sensor system of claim 8, wherein the transducer is in wireless electrical communication with the mobile application.

12. The AC filter sensor system of claim 5, wherein the notification feature sends a notification to a user when a threshold value is exceed.

13. The AC filter sensor system of claim 5, wherein the hose is attached to the port.

14. The AC filter sensor system of claim 5, wherein the mobile application is comprised of a tracking feature.

15. The AC filter sensor system of claim 12, wherein the threshold value is determined by the pressure differential measuring transducer.

16. The AC filter sensor system of claim 5, wherein the port is a cube port.

17. The AC filter sensor system of claim 5, wherein the battery is a disposable battery.

18. The AC filter sensor system of claim 6, wherein the fastener penetrates the body.

19. A method of using an AC filter sensor system, the method comprising the steps of:
placing a device of an AC filter sensor system in an AC unit;
receiving a notification from a mobile application of the AC filter sensor system; and
receiving a new AC filter from a supplier that received the notification.

20. The AC filter sensor system of claim 19, wherein the notification informs a user and the supplier that an AC filter of the AC unit need replaced.
